(19) United States
(12) Patent Application Publication
(10) Pub. No.: US 2024/0196854 A1
(43) Pub. Date: Jun. 20, 2024

(54) SMALL ANIMAL TOILET HAVING A SLOPE

(71) Applicant: Lilly&Bruce GmbH, Nürnberg (DE)

(72) Inventors: Jan HRDINA, Tamm (DE); Michael SCHOLZ, Nürnberg (DE)

(21) Appl. No.: 18/554,775

(22) PCT Filed: Apr. 15, 2021
(86) PCT No.: PCT/EP2021/059738

§ 371 Date: Oct. 10, 2023

(51) Int. Cl. A01K 1/01

(52) U.S. Cl. CPC A01K 1/0107

(57) ABSTRACT

The present invention relates to a small animal toilet, comprising a housing that has a litter compartment, which is designed for receiving litter, and an entrance, which is connected to the litter compartment via a path in order to allow a small animal to access the litter compartment; wherein the path comprises at least one region having a slope; wherein the path comprises at least one region having a slope; wherein a height difference of the slope is such that a small animal can spread its paws when it moves along the slope from the litter compartment to the entrance.

### 1. FIELD OF THE INVENTION

The present invention relates to a small animal toilet, in particular a cat toilet, with a slope, as well as a method for manufacturing and the use of the small animal toilet.

### 2. BACKGROUND OF THE INVENTION

Small animal toilets enable small animals, for example pets and domestic animals such as dogs or cats, to do their toilet business on an absorbent bed of litter. The small animal toilets are often placed in the living room of the small animal owner. The litter not only absorbs the urine, but also but also makes it possible to bury faeces. Common materials for litter or bedding are clay minerals such as bentonite, silicate gel or organic materials such as wood or straw. After entering the small animal toilet, litter residues often settle in the fur and on the paws of the animals. The litter is then carried out of the small animal toilet by the small animal and spread outside the toilet, which can lead to hygiene and odour problems. The litter must therefore be extensively collected and disposed of after each visit to the toilet by the animal.

In order to reduce the spread of litter from the toilet, mats are known which are laid out in front of a small animal toilet in order to retain a part of the litter that is carried out onto the mat. To improve the wiping or retention effect, these mats often comprise protrusions, for example knobs, on their surfaces. However, animals often find walking over such surfaces unpleasant, so that the animal is tempted to take the shortest route over the mat or to jump over the mat. Furthermore, even if an animal moves over the entire path of the mat without taking a shorter route, the litter is still often insufficiently retained on the mat. The litter is then undesirably distributed outside the mat despite overrunning the mat. This often leads to a not insignificant amount of litter being distributed in the vicinity of the small animal toilet despite the use of such mats.

In the state of the art, additional devices are known that guide cats over a defined wiping path, as described for example in U.S. Pat. No. 6,367,420 B1 or U.S. Pat. No. 6,412,440 B2. The disadvantage of these arrangements is that the additional wiping devices are arranged outside the actual toilet, which is very space-consuming and thus also takes up a lot of (living) space. In addition, the wiped litter does not remain in the toilet but is collected outside the toilet, which can lead to hygiene problems and unpleasant odours.

The document US 2019/0274273 A1 describes a cat litter tray which comprises a pathway within the litter tray which a cat must follow when entering or leaving the litter tray, wherein the litter wiped off on the pathway falls back into the litter container.

All known approaches have the problem that a not insignificant amount of litter remains on the paws of the animal, which is then distributed in the environment.

Thus, there is a need for an improved small animal toilet that provides a compact, effective and hygienic system to prevent litter from being carried out of the toilet into the environment.

### 3. DESCRIPTION OF THE INVENTION

The above problems are solved by a small animal toilet according to claim 1, a method for manufacturing the small animal toilet according to claim 14, and the use of the small animal toilet according to claim 15.

The present invention relates to a small animal toilet, in particular a cat toilet, comprising a housing having a litter compartment adapted to receive litter and an entrance connected to the litter compartment via a pathway for providing access to the litter compartment for a small animal, wherein the pathway comprises at least one region having a slope, wherein a height difference of the slope is dimensioned to cause a small animal to spread its paws as it moves from the litter compartment to the entrance along the slope.

With the small animal toilet according to the invention, a small animal can be guided over a defined path inside the housing. On this path, it also loses in particular the litter, which is located, for example, on or between the toes or also between the toes and pads of the small animal's feet. The inventors have discovered that some of the litter can accumulate between the toes of the paws of the small animal. Further, the inventors have surprisingly found that the animals lose this litter during a straddling movement when the small animals take a suitably large downward step. The small animal toilet according to the invention allows an opening movement of the paws during the downward movement of the animal, and thus a release of the litter from the paws. This enables a more effective litter removal compared to small animal toilets according to the state of the art. When entering the small animal toilet according to the invention via the entrance, a small animal can first move upwards along the path towards the litter compartment to do its toilet business there. In order to leave the small animal toilet according to the invention, the animal performs a corresponding opposite downward movement from the litter compartment along the path in the direction of the entrance. The small animal toilet according to the invention is not limited to embodiments with only one entrance as access to the litter compartment, but can also comprise further entrances. The further entrances can thereby also be provided without a slope, as long as the small animal uses a path with a slope when leaving the litter compartment, so that the litter can be removed according to the invention. The inventors have surprisingly found that if a sufficiently large slope is provided, an animal will open its paws and/or spread its toes during the downward step.

In a further embodiment, an opening movement of the paws can also be induced by an upward movement of the small animal. In this case, the slope may also comprise a corresponding incline or be formed as an incline that must be overcome upwards by a small animal in order to move from the litter compartment upwards along the path towards the entrance. A person skilled in the art will understand that the features of the path of the invention described herein in connection with a downward slope, for example in terms of dimensioning and arrangement, may also apply in an analogous manner to a path with an upward slope. For example, instead of being in the form of a stairway leading down from the litter compartment, the path may be provided as a corresponding stairway leading up from the litter compartment to remove litter from the small animal.

The slope according to the invention is not only to be understood in a strictly mathematical sense as a negative gradient. Rather, it describes a region of the path that comprises a certain height difference that a small animal must overcome with one step downwards. In other words, a small animal in the region of the slope is induced to overcome a certain height difference downwards with one step. All slopes suitable for small animals can be provided. Which slope respectively height difference is suitable to induce a corresponding opening of the paws can depend on the species, breed and physiognomy of the respective small animal. The height difference should always be sufficiently large so that the small animal has to spread its paws when stepping down. On the other hand, the height difference can also preferably be selected so that it is not too large so that a small animal can overcome it with one step without having to jump, for example. It will be understood that the region with the slope can be located at any point along the path. The path may also comprise a number of successive regions with slope, which further improves the cleaning effect. The litter compartment and/or the path may preferably be arranged in the housing. Thus, all components of the small animal toilet according to the invention that come into direct contact with litter can be separated from the environment, which enables effective retention of litter in the housing. The litter compartment and/or another element of the small animal toilet can also be formed as a separate element. This may allow for separate replacement, facilitating, for example, cleaning or, in the case of a separately formed litter compartment, refilling of litter. Furthermore, the litter compartment can be formed in one piece. This can advantageously prevent urine, for example, from being released from the litter compartment into the environment. This can be the case, for example, with cats that urinate while standing and therefore not directly into the litter, but against a side wall.

In a preferred embodiment, the slope extends from a first path portion to a second path portion, wherein the first path portion is arranged at a first height with respect to a housing bottom and wherein the second path portion is arranged at a second height which is lower than the first height, wherein the height difference between the first height and the second height is 2-30 cm, preferably 3-20 cm, most preferably 4-10 cm.

Generally, a suitable minimum height difference between the first height and the second height may be 2 cm, preferably 3 cm and most preferably 4 cm. Further, a suitable maximum height difference between the first height and the second height may be 30 cm, preferably 20 cm and most preferably 10 cm. The first height and the second height may be formed in such a way that a space is formed underneath the path which can accommodate stripped litter. For example, the space may be bounded on its lower side by the bottom of the housing. In this way, the stripped litter advantageously remains in the housing, which improves hygiene when using the small animal toilet. The second height is arranged suitably low below the first height, so that the height difference causes the toes to spread or the paws to open when stepping downwards. A suitable height difference for ordinary domestic cats may be, for example, 3-18 cm, preferably 6-12 cm, even more preferably 8-10 cm, and most preferably 9 cm. Generally, a suitable minimum height difference for common domestic cats may be 3 cm, preferably 6 cm, further preferably 8 cm, and most preferably 9 cm. Further, a suitable maximum height difference for common domestic cats may be 18 cm, preferably 12 cm, more preferably 10 cm and most preferably 9 cm. A person skilled in the art will understand that the effect according to the invention can also be achieved for other small animals, which are larger or smaller, with a different height difference adapted to the respective small animal. For this purpose, a suitable height difference can be selected at which the small animal spreads its paws in a downward step. At the same time, it is preferable to choose a height difference that is not too large so that the small animal can overcome it in one step without having to jump. This ensures on the one hand that a wiping effect is achieved by opening the paws in the downward movement. On the other hand, a slope can be provided that is preferably not too large so that the small animal can overcome the slope with a normal walking movement without having to jump. The reference to the first and second height does not have to be limited to the housing bottom, but can also be made with reference to another element of the small animal toilet or a floor on which the small animal toilet stands. Other sections may also be provided along the path before or after the first or second portion, each with the same or different slopes or height differences. Thus, for example, an animal can be caused to negotiate several portions with one or more suitably large differences in height, which improves the wiping effect along the path.

In a preferred embodiment, the housing comprises at least one housing side wall, wherein the at least one housing side wall comprises a housing opening forming the entrance.

The housing may be formed in such a way that it forms an inner space with the housing bottom and the at least one housing side wall. For example, the housing may be formed round or square, e.g. quadrangular. The housing may also comprise several housing side walls and form, for example, a square inner space with the housing bottom. The housing inner space may be formed open on its upper side or at least partially closed by one or more walls or covers arranged on the housing upper side. The housing opening, the path, as well as the litter compartment may preferably be formed sufficiently large so that a small animal can move in or through it. The path may preferably be designed in such a way that a small animal cannot avoid the slope on its way from the litter compartment to the entrance. The housing opening may, for example, be closed by a hinged flap to prevent odours from developing outside the small animal toilet.

In another embodiment, the small animal toilet may comprise a plurality of modular parts that together form an outer surface of the small animal toilet. For example, the housing may form a first modular part of the small animal toilet. The housing may comprise a floor at the bottom of the housing, a cover at the housing upper side and three side walls forming an inner space of the housing. Due to the lack of a side wall on one side of the housing access to the inner space of the housing may be provided from that side, through which, when assembling the modular small animal toilet, the path may be inserted into the inner space. The path may be accommodated largely in the inner space of the housing. For example, the inner space of the housing may accommodate the path, which is in the form of a staircase. The housing with the staircase accommodated therein may then be understood as a stair unit.

Further, the litter compartment may form a second modular part of the small animal toilet. The litter compartment may comprise a bottom and four side walls that form a second inner space. The litter compartment may comprise an open upper side through which the litter disposal container may be inserted into the inner space of the litter compartment. The first modular part (housing) and the second modular part (litter compartment) may be joined together to form the small animal toilet according to the invention. The two modular parts may be arranged in such a way that the open side of the housing, on which no side wall is provided, faces inwards, wherein, when the small animal toilet is assembled, a side wall of the litter compartment may close the open side. The remaining, not inside situated side walls of the litter compartment may then, together with the side walls of the housing, form the lateral outer surfaces of the modular small animal toilet according to the invention.

In a preferred embodiment, the path is shaped in the form of a staircase with at least one step, wherein the at least one step comprises a vertical step height of 2-30 cm, preferably 3-20 cm, most preferably 4-10 cm.

The staircase may also comprise two, in particular three or more steps, wherein a small animal must overcome a corresponding height difference with each step in order to return to the entrance.

Thus, the cleaning effect along the path may be further improved. When multiple steps are provided, the respective steps may be of the same or different height. The at least one step may comprise a horizontal tread with a tread depth of 5-30 cm, preferably 10-25 cm, most preferably 15-20 cm. Thus, depending on the physique and type of small animal, a suitable shape of staircase may be provided which enables the small animal to safely pass from one step to the next and, at the same time, to descend a certain height with each step so that spreading of the paws is induced. When providing multiple steps, the respective steps may be of equal or different depths. One skilled in the art will understand that the present invention is not limited to a classic staircase shape with horizontal treads and vertical steps.

Rather, the path may take any suitable shape defining a region of suitable slope, for example a suitably sloping undulating shape or an incline. It is only important that the region slopes so steeply that a small animal is forced to spread its paws as it moves down the slope.

In a preferred embodiment, the path comprises a path bottom having at least one bottom opening formed so that litter deposited from the litter compartment may fall through the bottom opening.

The loosened or wiped off litter may fall through the bottom openings of the path into the space below the path bottom. This may prevent the litter from being once loosened or wiped off can be reliably removed from the animal and cannot be re-entered via the paws. This may improve the detention effect of the toilet according to the invention. The loosened litter may be collected in a space underneath the path bottom which may be located in the housing. Thus, falling litter remains in the small animal toilet according to the invention, which further improves hygiene. The space may include a removable litter collection device, which may facilitate the disposal of loosened and collected litter. Further, additional knobs or otherwise formed protrusions may also be provided on the upper side of the path-bottom, which may assist in removing litter from the lower side of a small animal's paws. This may further improve the effectiveness of litter removal.

In a preferred embodiment, at least one bottom opening is chamfered on its upper side in order to form a funnel opening upwards.

Due to the enlarged openings at the upper side, an improved collection and removal of loosened litter may be made possible. The inclines of the funnel may preferably be steep enough so that loosened litter can fall down through the openings on its own. This may prevent loosened litter from being re-entered by the small animal, which improves cleaning efficiency. For example, the inclines of the funnel with respect to a horizontal direction may comprise an inclination between 10° and 80°, preferably between 25 and 65° and most preferably 45°. Thus, a sufficiently steep slope is ensured and at the same time the one or more openings at the upper side of the path bottom is enlarged. In further embodiments, the one or more bottom openings may also be formed in a different shape.

In a preferred embodiment, the small animal toilet comprises no further means for removing litter from the paws of a small animal.

According to the invention, an effective and compact system may be provided, so that additional means, such as, for example, floor mats or other additional devices, can be omitted.

In a preferred embodiment, the path bottom at the entrance is formed at substantially the same height as the lower side of the housing opening.

Preferably, the lower side of the housing opening may be substantially at ground level. In this way, a low entrance to the small animal toilet may be provided, which is particularly advantageous for small animals, but also for animals with a mobility limitation, for example old and sick animals.

In a preferred embodiment, the litter compartment comprises at least four litter compartment side walls and a litter compartment bottom which form an inner space, wherein between the litter compartment bottom and the at least four litter compartment side walls preferably rounded inner corners and/or rounded inner edges are provided.

The rounded inner corners and edges may allow easy cleaning of the litter compartment, as no litter can get stuck in the corners respectively edges. This may be particularly advantageous when using commercially available clumping litter, as this clumps together after absorbing moisture and adheres to the inner side walls and corners of the litter compartment.

In a preferred embodiment, the litter compartment comprises a recess portion on at least one litter compartment sidewall, wherein the height of the litter compartment sidewall in the recess portion is less than the height of the litter compartment sidewall outside the recess portion, wherein the path bottom extends beyond the top edge of the litter compartment sidewall in the recess portion into the inner space of the litter compartment.

Therefore, the entry into the litter compartment may be facilitated for a small animal and a platform projecting at least partially into the litter compartment may be provided, from which a small animal can move into and out of the litter compartment. Also, an increased stability of the path at the entry or exit area into the litter compartment may be achieved, respectively, as the platform may be supported on the upper side of the wall of the recess portion. The platform may be configured and formed in such a way that it provides sufficient space for an animal to stand and/or sit on it, for example. The platform may also extend sufficiently far into the litter compartment so that animals may be able to do their toilet business directly on the platform without having to enter the litter compartment. Particularly older animals may find it uncomfortable to walk on litter and may therefore be reluctant to enter the litter compartment area. Providing an appropriate platform allows an animal to urinate, for example, directly on the platform, wherein the urine passes through appropriate openings in the bottom of the platform into the litter compartment below. This may also prevent urine from getting outside the litter compartment, for example into other regions of the small animal toilet.

Further, when the small animal moves from the bottom of the litter compartment back onto the platform, for example with a jump or a large step, it may advantageously already lose litter by moving upwards. The litter removed from the animal in this way may fall through the openings in the bottom of the platform directly back into the litter store below. This may further improve the cleaning effect of the device according to the invention.

In a preferred embodiment, the path may be limited by at least one side wall, wherein the at least one side wall is at least partially formed by at least one housing side wall and/or at least one litter compartment side wall. Thus, the separate formation of side walls by the path may be omitted, thereby simplifying the entire device and saving material costs.

In a preferred embodiment, the small animal toilet further comprises a litter disposal container, wherein the litter disposal container is arranged preferably in the litter compartment, and wherein the litter disposal container comprises outer walls which are formed to separate an inner space of the litter disposal container from the inner space of the litter disposal container from an inner space of the litter compartment.

Usually, used or contaminated litter, e.g. litter that is contaminated with urine or faeces, must be regularly removed from the small animal toilet into a container separate from the small animal toilet. Cleaning out the small animal toilet may lead to undesired pollution of the surroundings. The provision of an appropriately integrated litter disposal container in the litter compartment may help to prevent litter from escaping from the litter compartment during emptying. According to the invention, litter that is inadvertently dispersed into the environment during clearing may be collected by the surrounding litter compartment. This may prevent the environment from being polluted by used litter. Also, due to the integrated arrangement of the litter disposal container in the small animal toilet according to the invention, the acquisition of a separate disposal container may be omitted. This may simplify the use and cleaning of the small animal toilet.

In a preferred embodiment, the litter compartment and the path extend in a substantially longitudinal extension direction and in a substantially transversal extension direction, wherein the longitudinal extension is greater than the transversal extension.

In one embodiment, the litter compartment and the path may be arranged in the housing parallel and directly adjacent to each other along their longitudinal sides and are preferably separated from each other by at least one litter compartment sidewall and/or one path sidewall. Such a design may provide both a suitably long path and a suitably large litter compartment within the housing. Thus, a compact design of the small animal toilet according to the invention may be obtained. At the same time, an optimal use over the entire longitudinal extension direction of the housing may be achieved with a path within the housing that is as long as possible. In a preferred embodiment, the entrance may be arranged parallel to the longitudinal extension direction and the path exit may be arranged perpendicularly thereto, i.e. parallel to the transversal extension direction. This allows the small animal to turn within the small animal toilet according to the invention in order to reach the litter compartment. In this way, a particularly compact construction of the small animal toilet may be made possible. In a further embodiment, the inner lying side wall of the litter compartment may thereby adjoin the path, wherein no separate path side wall is formed by the path itself.

In a preferred embodiment, the housing comprises a cover on a housing upper side, which provides lockable access to at least one, preferably all, components of the small animal toilet arranged in the housing.

The cover may be formed movable, e.g. swivably fixed, or completely removable and may consist of one or more components. This may provide an access for a user from the upper side of the small animal toilet to individual or all components of the small animal toilet located in the housing without having to remove further parts of the housing, such as the side walls. This simplifies the use, for example the filling and emptying of the litter compartment, as well as the cleaning of the individual components. The cover may be provided with or without further holding means, for example a handle, for better transport of the small animal toilet. The cover may be formed in such a way that it may seal all components of the small animal toilet arranged in the housing, in particular the litter disposal container, in an airtight manner. The cover may be formed to fit as precisely as possible so that it can close the upper sides of the respective components. Thus, odour development in the environment of the small animal toilet according to the invention may advantageously be avoided. The cover may be formed in one piece, so that no separate covers are necessary for closing the individual components. This simplifies handling and also saves material costs. The cover may also consist of several elements in order to provide partial access to the small animal toilet. This may allow easy and flexible cleaning and replacement of the respective components. In another embodiment, the cover may be arranged only on the upper side of the litter compartment to cover it in a closable manner. The cover may be flush with an upper surface of the cover of the housing at its upper side and thus together form an upper surface of the small animal toilet according to the invention. In one embodiment, the bottom of the housing and the bottom of the litter compartment may be flush with each other, thus together forming a lower surface of the small animal toilet according to the invention.

The invention also relates to a method of manufacturing a small animal toilet, wherein at least one, preferably all, of the components of the small animal toilet are produced by deep drawing and/or casting of a plastic material.

For manufacturing one or more components, all suitable plastics or other materials known to a person skilled in the art for the manufacture of small animal toilets may be used. The individual components may be made from the same or different materials. Non-limiting examples of suitable plastics are, for example, acrylonitrile-butadiene-styrene or also recycled materials or bioplastics. In particular, deep-drawing may enable cost-effective manufacture of some or all of the components of the small animal toilet according to the invention. However, the manufacturing method is not limited to the aforementioned methods, but includes all suitable methods and materials known to a person skilled in the art for manufacturing small animal toilets. For example, one or more components of the small animal toilet may be manufactured using a 3D printing method. In this process, one or more components of the small animal toilet may also be formed as separate components.

Thus, single components may be removed from the housing, which simplifies cleaning. The single components may also be assembled in the form of a modular system to form the small animal toilet according to the invention. This may allow simplified replacement if, for example, single components are defective. In addition, production and logistic costs may be saved, since smaller packaging sizes may be used for the single components. Also, single or all modular components, for example the path and the housing, may be formed in such a way that they can be arranged nested for transport, in order to enable space-saving transport and to save further logistics costs.

Also, one or more components may be formed integrally, which may increase stability.

The invention also relates to a use of the small animal toilet according to the invention as previously described, wherein a small animal moves in order to leave the small animal toilet from the litter compartment along the path to the entrance, wherein the small animal is caused to spread its paws as it passes the slope.

By the use according to the invention it may be achieved that litter, which the small animal carries between its toes, is loosened in the region of the slope by the spreading movement. Thus, an improved removal of litter in the small animal toilet according to the invention may be achieved.

### 4. DESCRIPTION OF THE FIGURES

For a better understanding of the present invention and to illustrate its practical applicability, figures are provided and referred to below. It should be understood that the figures are merely exemplary embodiments and thus in no way limit the scope of the claimed invention. In particular, one skilled in the art understands that the elements of the embodiments shown in the figures may be modified and combined as necessary without departing from the subject matter of the invention as defined in the claims.

FIG. 1 shows a general view of an embodiment of the small animal toilet with cover according to the invention.

FIG. 2 shows a general view of an embodiment of the small animal toilet according to the invention without cover.

FIG. 3 shows an exploded view of an embodiment of the small animal toilet according to the invention.

FIG. 4A shows a cross-sectional view of an embodiment of the path according to the invention.

FIG. 4B shows a cross-sectional view of an embodiment of the litter compartment according to the invention.

FIG. 5 shows a general view of a further embodiment of the small animal toilet with cover according to the invention.

FIG. 6 shows an overall view of a further embodiment of the small animal toilet according to the invention without a cover.

FIG. 7 shows a cross-sectional view of a further embodiment of the small of the small animal toilet according to the invention.

### 5. DETAILED DESCRIPTION OF THE PREFERRED EMBODIMENTS

In the following, the present invention is described in detail with reference to the accompanying drawings, which show exemplary embodiments of the present invention. However, it is possible that the present invention may also be embodied in different ways, so that the following embodiments are not to be understood as limiting the scope of protection of the invention. Rather, the embodiments described are intended to illustrate the scope of the invention to a person skilled in the art by way of example. Identical reference signs denote identical elements in the following figures. If no reference signs are provided on an element in different views, this is merely due for clarity of the drawings shown. However, a person skilled in the art may easily deduce the arrangement and design of the corresponding elements from the various views.

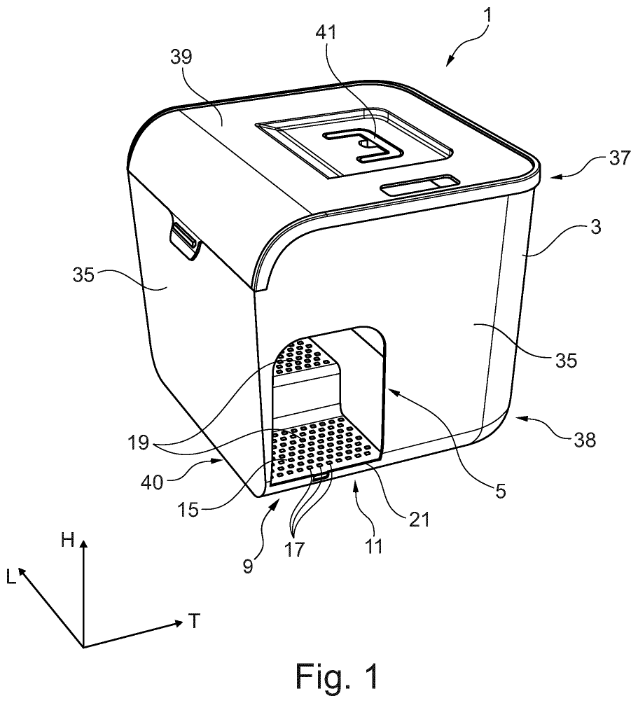

FIG. 1 shows a general view of an embodiment of the small animal toilet 1 according to the invention with cover 39. Inside the housing 3 closed by the cover 39, the parts or components of the small animal toilet 1 according to the invention are arranged, which are described in detail below. The removable cover 39 arranged on the housing upper side 37 comprises a handle 41 which is swivellably arranged on the cover 39 and can be retracted into the cover 39. The cover 39 may form an airtight seal on the housing upper side 37 of the small animal toilet 1, in particular for the internal litter disposal container 45 (not shown). The handle 41 may also be omitted to simplify the construction of the cover. On the opposite housing lower side 38, the housing 3 comprises a housing bottom 40 and four vertical housing side walls 35 there between. On one side, a housing opening 5 is arranged in the housing side wall 35, which is substantially even with the ground on which the small animal toilet 1 stands. The lower side 21 of the housing opening 5 therefore does not comprise a high entrance step or wall which must first be overcome by a small animal when entering the small animal toilet 1. The housing opening 5 forms an entrance 11 to the path 9, which is arranged in the small animal toilet 1. In the embodiment shown, the path 9 is formed in the shape of a staircase leading upwards, as seen from the entrance 11, wherein the path bottom 15 of each step 19 of the staircase comprises a plurality of bottom openings 17. Thus a grid-like structure is provided through which litter loosened by the spreading of the paws during the downward movement may fall downwards into the housing 3 when a small animal moves along the path 9 from the litter compartment 7 back towards the entrance 11. The stairs is not fixedly connected to the housing 7, but is provided as a component that can be removed from the housing 7.

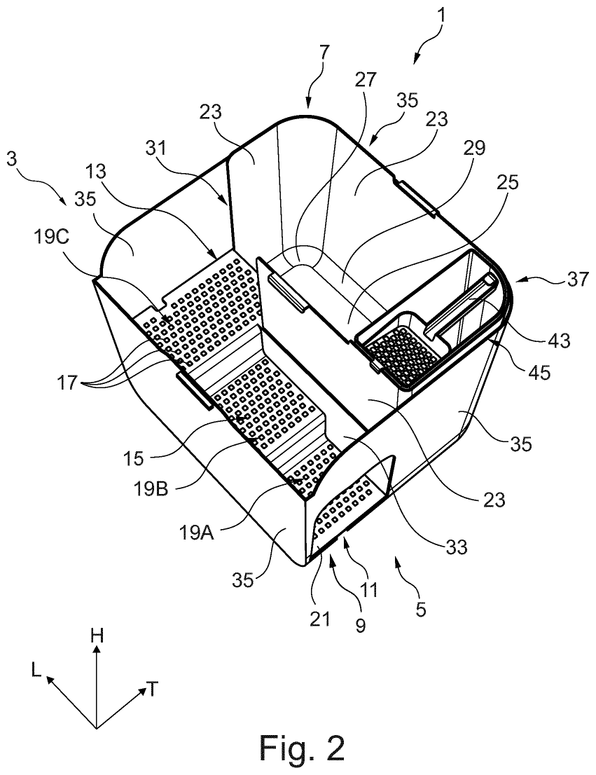

FIG. 2 shows a general view of an embodiment of the small animal toilet 1 according to the invention without the cover 39 at the housing upper side 37. In particular this view shows the arrangement of the single components arranged in the housing 3 of the small animal toilet 1 according to the invention. As shown, the path 9 extends from the housing opening 5 in the longitudinal direction of extension L to the housing side wall 35 opposite to the opening. Parallel thereto the litter compartment 7 extends in longitudinal extension direction L. The litter compartment 7 comprises a litter compartment bottom 25 which extends parallel to the housing bottom 40. Furthermore, the litter compartment 7 comprises litter compartment side walls 23 which extend perpendicularly to the housing bottom 40 and the litter compartment bottom 25 in the direction of the height H. The longitudinal litter compartment side wall 23 extends parallel to the adjacent longitudinal housing side wall 35. Correspondingly, the litter compartment side walls 23 extending in the transversal direction of extension T extend parallel to the adjacent transversal housing side walls 35. A longitudinal litter compartment side wall 23 extends centrally through the housing 3 and separates the litter compartment 7 and the path 9. This litter compartment side wall 23 does not extend completely to the opposite housing side wall 35 but just until to a recess portion 31. At this point an uppermost step 19C of the path 9 projects into the litter compartment 7 and forms the path exit 13 and a platform over which a small animal may enter the litter compartment 7. As can be seen from the figure, the entrance 11 respectively the housing opening 5 extends along the transversal direction, whereas the path exit 13 extends perpendicularly thereto along the longitudinal direction. A small animal moving along the path bottom 15 along the path 9 must therefore turn in order to reach the litter compartment 7. The inner space of the litter compartment 7 comprises between the litter compartment bottom 25 and the litter compartment side walls 23 rounded inner corners 27 and rounded inner edges 29. In the embodiment shown, seen from the entrance 11, the litter compartment 7 and the path 9 are separated by a path sidewall 33 in the lower region of the path 9 to the end of the middle step 19B. In the vertical direction arranged above the litter compartment side wall 23 is arranged. The path side wall 33 and the litter compartment side wall 23 are flush with each other. In the embodiment shown, a litter disposal container 45 is arranged on the transversely running litter compartment side wall 23. This is open at the top so that a user can remove used or exhausted litter from the 30 inner space of the litter compartment 7 and pour it into the inner space of the litter disposal container 45. The respective inner spaces of the litter compartment 7 and the litter disposal container 45 are separated from each other by appropriate walls. The opening of the litter disposal container 45 is flush with an upper side of the litter compartment container 7 and the housing upper side 37. Furthermore, holding means in the form of recesses or projections are formed in the inner space of the litter disposal container 45 on its upper side, which allow a litter disposal aid, for example a shovel 43, to be stored. In the shown embodiment, the shovel is arranged retractable in the upper region of the litter disposal container 45.

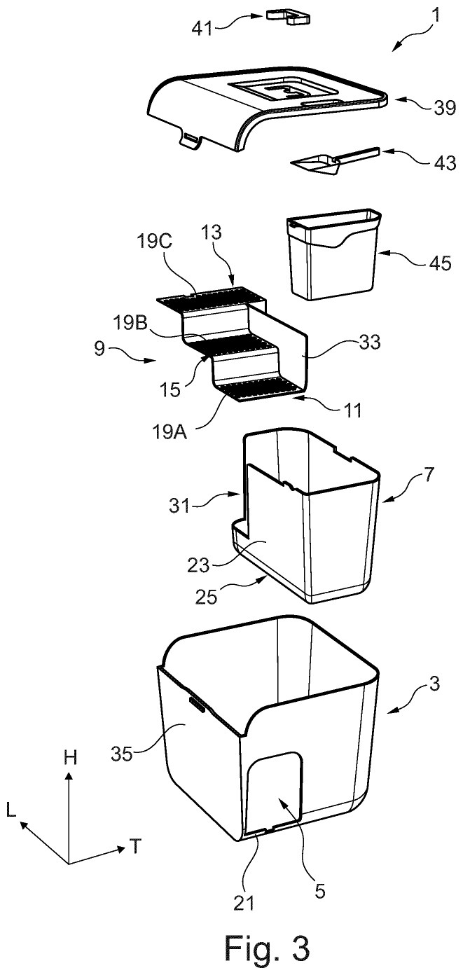

FIG. 3 shows an exploded view of an embodiment of the small animal toilet 1 according to the invention. In particular, the configuration and arrangement of components of the small animal toilet 1 is shown. In the example shown, housing 3, litter compartment 7, path 9, litter disposal container 45, shovel 43, cover 39 and handle 41 are formed separately. In the shown embodiment, all elements may be inserted one after the other into the housing 3 from above. Afterwards, the small animal toilet 1 may be closed with the cover 39.

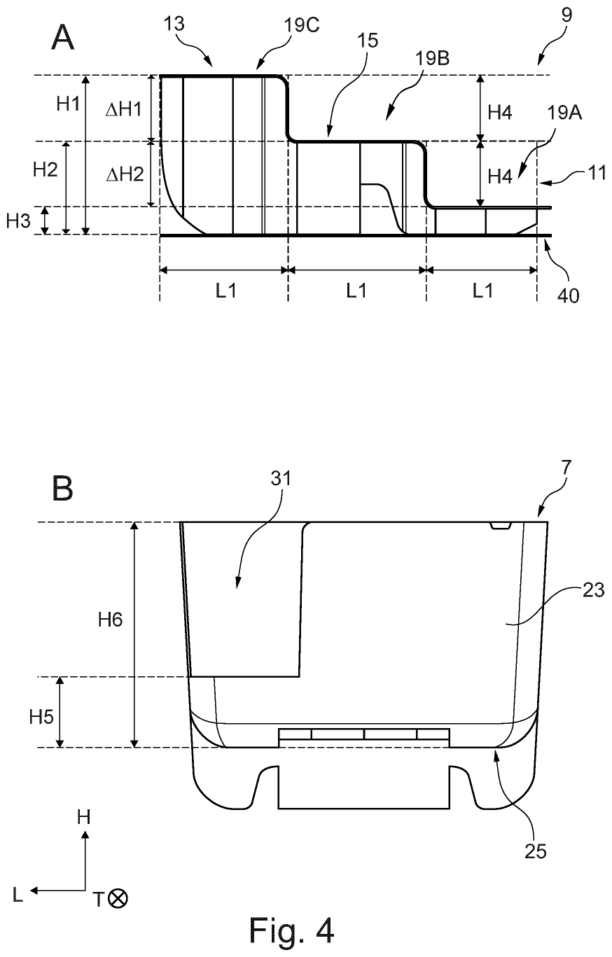

FIG. 4A shows a cross-sectional view of an embodiment of the path 9 according to the invention in the form of a staircase. In particular, a staircase shape declining in the longitudinal direction of extension L is shown with three steps 19A, 19B, 19C, wherein the respective steps 19 have horizontal tread depths L1 and vertical step heights H4. The path bottom 15 of step 19C at the path exit 13 is arranged at a first height H1. Further, after the first step 19C in the direction of entrance 11, a second step 19B is arranged at a second height H2, which is smaller than the first height H1, whereby a height difference ΔH1 is formed between the first step 19C and the second step 19B. Furthermore, after the second step 19B in the direction of the entrance 11, a third step 19A is arranged at a third height H3, which is smaller than the second height H2, whereby a height difference ΔH2 is formed between the second step 19B and the third step 19A.

The heights H1, H2 and H3 refer to the housing bottom 40. A small animal moving from the path exit 13 to the entrance 11 along the path 9 must therefore overcome a height difference ΔH1 and a height difference ΔH2 when leaving the small animal toilet 1 downwards. Both the height difference ΔH1 as well as the height difference ΔH2 is sufficiently large so that a small animal is induced to spread its paws during a downward step. This causes the animal to lose litter, which is on its paws or between its toes, with each downward step. Underneath the path floor 15 a space is arranged that allows to collect litter that has been loosened by the spreading of the paws and has fallen down through the bottom openings 17 in the path floor 15. As shown, the entrance height to the small animal toilet, which corresponds to height H3, is relatively small, so that the entrance 11 is arranged substantially at ground level.

FIG. 4B shows a cross-sectional view of an embodiment of the litter compartment 7 according to the invention. In particular, the recess portion 31 is shown, which is arranged in the litter compartment side wall 23. The litter compartment side wall 23 comprises a height H6 outside the recess portion. Inside the recess portion 31, the litter compartment sidewall 23 comprises a lower height H5 so as to form an opening allowing access to the litter compartment 7. The heights H5 and H6 refer to the litter compartment bottom. Below the litter compartment bottom 25 spacers are also shown, which are dimensioned and shaped so that the litter compartment bottom 25 may be arranged in the housing 3 at a defined height in relation to the housing bottom 40.

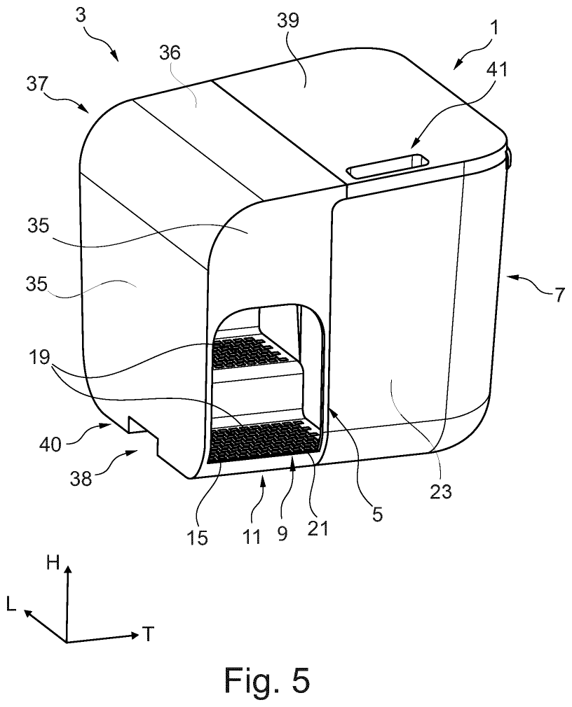

FIG. 5 shows a general view of a further embodiment of the small animal toilet with cover 39 according to the invention. The removable cover 39, which is arranged on the upper side of the litter compartment 7, comprises a handle 41 in the form of a recess. The cover 39 may thereby provide an airtight closure at the upper side of the litter compartment 7 of the small animal toilet 1. The handle 41 may also be omitted to simplify the construction of the cover. The cover 37 and a housing cover 36 arranged on the upper side of the housing 3 are flush with each other. On the opposite housing bottom 38, the housing 3 comprises a housing bottom 40 and three vertical housing side walls 35 there between. At a fourth, inner lying side (not shown) no housing side wall is arranged. On one side, a housing opening 5 is arranged in the housing side wall 35, which is substantially arranged at ground level with the base on which the small animal toilet 1 is placed. The lower side 21 of the housing opening 5 therefore does not comprise a high entrance step or wall which must first be overcome by a small animal when entering the small animal toilet 1. The housing opening 5 forms an entrance 11 to the path 9, which is arranged in the small animal toilet 1. In the embodiment shown, the path 9 is formed in the shape of a staircase leading upwards, as viewed from the entrance 11, wherein the path bottom of each step 19 of the staircase comprises a plurality of bottom openings 17. This provides a grid-like structure through which litter loosened by the spreading of the paws during the downward movement may fall downwards into the housing 3 when a small animal moves along the path 9 from the litter compartment 7 back towards the entrance 11. The stairs are not permanently connected to the housing 7, but are provided as a component that can be removed from the housing 7.

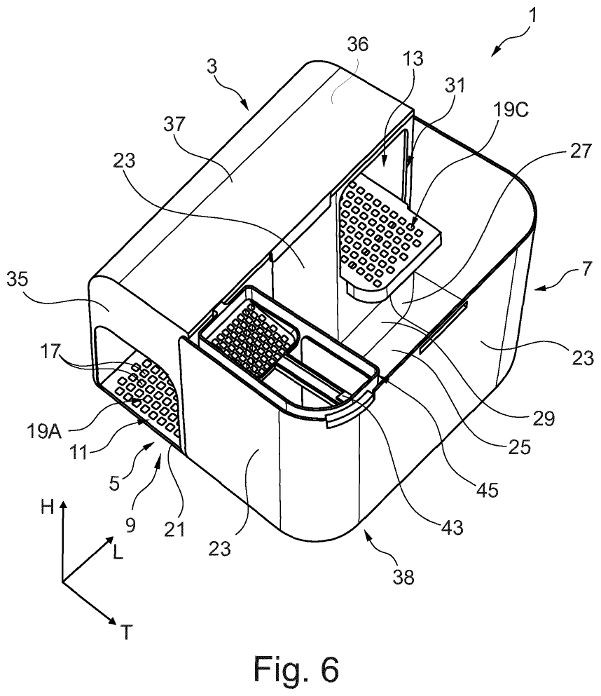

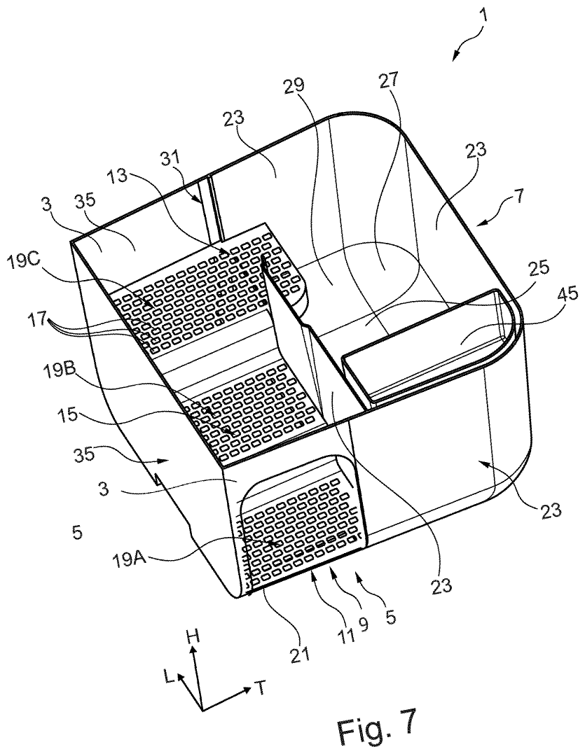

FIG. 6 shows a general view of a further embodiment of the small animal toilet according to the invention without cover and FIG. 7 shows a cross-sectional view of the further embodiment of the small animal toilet according to the invention. In particular, these figures show the arrangement of the individual components of the small animal toilet 1 according to the invention arranged in the housing 3. As shown, the path 9 extends from the housing opening 5 in the longitudinal direction of extension L to the housing side wall 35 opposite the opening. Parallel thereto, the litter compartment 7 extends in the longitudinal direction of extension L. The litter compartment 7 comprises a litter compartment bottom 25. Furthermore, the litter compartment 7 comprises litter compartment side walls 23 which extend perpendicularly to the litter compartment bottom 25 in the direction of the height H direction. A longitudinal litter compartment side wall 23 runs centrally through the housing 3 and separates the litter compartment 7 and the path 9. This litter compartment side wall 23 does not extend completely to the opposite housing side wall 35, but only to a recess section 31. At this point an uppermost step 19C of the path 9 projects into the litter compartment 7 and forms the path exit 13 and a platform over which a small animal may enter the litter compartment 7. As can be seen from the figures, the entrance 11 or housing opening 5 extends along the transversal direction, whereas the path exit 13 extends perpendicularly thereto along the longitudinal direction. A small animal moving along the path bottom 15 along the path 9 must therefore turn off in order to reach the litter compartment bottom 7. The inner space of the litter compartment 7 comprises between the litter compartment bottom 25 and the litter compartment side walls 23 rounded inner corners 27 and rounded inner edges 29. In the embodiments shown, as viewed from the entrance 11, the litter compartment 7 and the path 9 are separated from each other by an internal litter compartment sidewall 23. In the embodiment shown, a litter disposal container 45 is arranged on the transversely extending litter compartment side wall 23. This is open at the top so that a user may remove used or exhausted litter from the inner space of the litter compartment 7 and dispose this in the inner space of the litter disposal container 45. The respective inner spaces of the litter compartment 7 and the litter disposal container 45 are separated from each other by respective walls. The opening of the litter disposal container 45 closes flush with an upper side of the litter compartment 7 and the housing upper side 37. Further, holding means are formed in the inner space of the litter disposal container 45 on its upper side to allow a litter disposal aid, for example a shovel 43, to be stored. In the embodiment shown, the shovel is retractably arranged in the upper region of the litter disposal container 45. As can be seen in FIG. 6, the inner space of the small animal toilet 1 is accessible from the top through the opening which is otherwise closed by the cover 39. The top of the housing 3 is closed by the housing cover 36. The cover 39 may be used to close the open upper sides of the litter compartment 7 and the litter disposal container 45. At the upper sides of the litter compartment side walls 23 and of the litter disposal container 45 there are provided interengaging holding means in the form of projections and recesses which allow the litter disposal container 45 to be hooked in and out into the inner space of the litter compartment 7. Thus the litter disposal container 45 may be removed separately from the litter compartment 7 and be used, for example, for emptying or cleaning. Of course, other types and forms of holding means may be provided alternatively or in addition thereto, which enable the litter disposal container 45 to be detachably fastened in the litter compartment 7 accordingly.

### 6. REFERENCE SIGNS

small animal toilet 1
housing 3
housing opening 5
litter compartment 7
path 9
entrance 11
path outlet 13
path bottom 15
bottom opening 17
first height of the path H1
second height of the path H2
third height of the path H3
height difference ΔH, ΔH1, ΔH2
step 19, 19A, 19B, 19C
vertical step height H4
tread depth L1
Lower side of housing opening 21
litter compartment side wall 23
litter compartment bottom 25
inner corner 27
inner edge 29
recess portion 31
height of the litter compartment side
wall inside of the recess portion H5
height of the litter compartment side
wall outside of the recess portion H6
path side wall 33
Housing side wall 35
Housing cover 36
Housing upper side 37
Housing lower side 38
Cover 39
Housing bottom 40
Handle 41
Scoop 43
Litter disposal container 45
Longitudinal direction of extension L
Transverse direction of extension T
Height H

What is claimed is:

1. A small animal toilet, in particular a cat toilet, comprising:
a housing comprising:
a litter compartment adapted to receive litter; and
an entrance connected to the litter compartment via a path, to allow a small animal access to the litter compartment;
wherein the path comprises at least one region with a slope,
wherein a height difference of the slope is dimensioned to cause a small animal to spread its paws when moving from the litter compartment to the entrance along the slope.

2. The small animal toilet according to claim 1, wherein the slope extends from a first path portion to a second path portion, wherein the first path portion is arranged at a first height with respect to a housing bottom and wherein the second path portion is arranged at a second height which is lower than the first height, wherein the height difference between the first height and the second height is 2-30 cm.

3. The small animal toilet according to claim 1, wherein the housing comprises at least one housing side wall, and wherein the at least one housing side wall comprises a housing opening which forms the entrance.

4. The small animal toilet according to claim 1, wherein the path is formed in the shape of a staircase with at least one step, wherein the at least one step comprises a vertical step height of 2-30 cm.

5. The small animal toilet according to claim 1, wherein the path comprises a path bottom with at least one bottom opening which is configured such that litter entering from the litter compartment can fall through the bottom opening.

6. The small animal toilet according to claim 1, wherein the at least one bottom opening is chamfered at its upper side to form an upwardly opening funnel.

7. The small animal toilet according to claim 1, wherein the small animal toilet comprises no further means for removing litter from the paws of a small animal.

8. The small animal toilet according to claim 1, wherein a path bottom at the entrance is formed at a substantially identical height as the lower side of the housing opening.

9. The small animal toilet according to claim 1, wherein the litter compartment comprises at least four litter compartment side walls and a litter storage bottom, which form an inner space, wherein between the litter compartment bottom and the at least four litter compartment side walls are preferably rounded inner corners and/or rounded inner edges provided.

10. The small animal toilet according to claim 9, wherein the litter compartment comprises a recess portion on at least one litter compartment side wall, wherein the height of the litter compartment side wall in the recess portion is less than the height of the litter compartment side wall outside the recess portion, wherein the path bottom projects over the upper edge of the litter compartment side wall in the recess portion into the interior of the litter compartment.

11. The small animal toilet according to claim 1, wherein the small animal toilet further comprises a litter disposal container, wherein the litter disposal container is arranged in the litter compartment, and wherein the litter disposal container comprises outer walls which are formed to separate an inner space of the litter disposal container from an inner space of the litter store.

12. The small animal toilet according to claim 1, wherein the litter compartment and the path extend in a substantially longitudinal direction of extension and in a substantially transversal extension direction, wherein the longitudinal extension direction each being greater than the transversal extension direction.

13. The small animal toilet according to claim 1, wherein the housing comprises a cover on a housing upper side, which cover provides a lockable access to at least one components of the small animal toilet arranged in the housing.

14. A method of manufacturing a small animal toilet comprising:
providing a housing comprising:
a litter compartment adapted to receive litter; and
an entrance connected to the litter compartment via a path to allow a small animal access to the litter compartment;
wherein the path comprises at least one region with a slope;
wherein a height difference of the slope is dimensioned to cause a small animal to spread its paws when moving from the litter compartment to the entrance along the slope; and
wherein at least one components of the small animal toilet is manufactured by deep drawing and/or casting a plastic material.

15. A method of using of a small animal toilet comprising:
providing a housing to be accessible by a small animal the housing comprising:
a litter compartment adapted to receive litter; and
an entrance connected to the litter compartment via a path to allow the small animal access to the litter compartment;
wherein the path comprises at least one region with a slope; and
wherein a height difference of the slope is dimensioned such that as the small animal moves to exit the small animal toilet from the litter compartment along the path to the entrance, the small animal is caused to spread its paws while crossing the slope.
